(19) United States
(12) Patent Application Publication
(10) Pub. No.: US 2003/0162160 A1
(43) Pub. Date: Aug. 28, 2003

(54) Interactive puzzle

(76) Inventors: Jack Horchler, Frankfort, IL (US); Daman Mucaro, Wayne, NJ (US)

Correspondence Address: Robert A. Yesukevich, Michael Best & Friedrich LLC, Suite 1900, 401 N. Michigan Avenue, Chicago, IL, 60611, US

(21) Appl. No.: 10/334,641

(22) Filed: Dec. 31, 2002

Related U.S. Application Data
(60) Provisional application No. 60/359,855, filed on Feb. 27, 2002.

(51) Int. Cl. G09B 25/00

(52) U.S. Cl. 434/406

(57) ABSTRACT

The invention provides an interactive, electronic, talking puzzle for amusing and creatively stimulating children. The interactive map includes form-fitting trays, which accept similarly shaped puzzle pieces. Additionally, the trays define hollows, which accept projections formed by the undersides of the puzzle pieces. When a puzzle piece is oriented properly and fitted into the matching tray, the projection of the puzzle piece penetrates the hollow of the tray. Further insertion of the puzzle piece into the tray depresses a membrane switch or other actuating button located in the hollow, so as to trigger a predetermined audio response. The response is programmed to relate to the State, region, American flag, Statue of Liberty or compass point that is represented by the puzzle piece.

### RELATED APPLICATION

The present application claims the benefit of co-pending U.S. provisional patent application Serial No. 60/359,855, filed Feb. 27, 2002.

### TECHNICAL FIELD

This invention relates generally to educational toys. More specifically, the invention relates to a puzzle for assembly by children, and to interactive electronic learning devices.

### BACKGROUND OF THE INVENTION

Children need to know their geographical relationship to their neighbors and the rest of the world. Classroom teachers are aware of the importance of geography, but only a limited amount of class time is available and many important subjects must be covered. On the other hand, memorizing a conventional map or a list of geographical facts does not seem to appeal to children.

Puzzle maps with pieces which fit into corresponding trays have been previously publicized. However, the amount and type of geographical information that can be imprinted on a conventional puzzle map is necessarily limited. Also, children do not seem to play with them for very long.

Electronic jigsaw puzzles are available, but jigsaw puzzles do not emphasize the shape of any particular piece. Additionally, the rather complicated process of solving an entire jigsaw puzzle does not teach that each geographical region is interesting and important in its own right.

A need exists for an interactive educational toy that makes it fun for children to learn about particular geographical regions. The new toy should include enough information to challenge the child. The new toy should focus the child's attention on the map and reward the child immediately when he or she correctly identifies geographical relationships. It would be desirable for the new toy to engage the child with simultaneous sight, sound and tactile experiences to stimulate the child's memory and promote recall of the learned information.

### SUMMARY OF THE INVENTION

The invention provides an interactive, electronic, talking puzzle for amusing and creatively stimulating children. One embodiment of the invention is a puzzle that includes an interactive map and puzzle pieces, corresponding to particular states of the United States of America. Other puzzle pieces resemble the American flag, the Statue of Liberty and major points of the compass. The interactive map includes form-fitting trays, which accept similarly shaped puzzle pieces. Additionally, the trays define hollows, which accept projections formed by the undersides of the puzzle pieces.

When a puzzle piece is oriented properly and fitted into the matching tray, the projection of the puzzle piece penetrates the hollow of the tray. Further insertion of the puzzle piece into the tray depresses a membrane switch or other actuating button located in the hollow, so as to trigger a predetermined audio response. The response is programmed to relate to the State, region, American flag, Statue of Liberty or compass point that is represented by the puzzle piece.

For example, orienting the Illinois puzzle piece properly and pressing it into the correct tray earns a verbal reward of “Illinois: The Prairie State! State capital: Springfield!” Orienting the Statue of Liberty properly and pressing it into its tray activates a musical rendition of “America, the Beautiful.”

One type of puzzle provided by the invention has dozens of distinctively shaped pieces. Each of the puzzle pieces is shaped or marked to symbolize an educational concept that is interesting to children and useful in later life. Each of the puzzle pieces includes a projection on its underside. The puzzle pieces are designed to fit into one and only one of a number of distinctively shaped trays. Each of the trays has a sensor which is actuated by the projection of the puzzle piece that fits the tray. The puzzle includes an electronic system for determining which one of the sensors is actuated. The electronic system uses this information to select an appropriate auditory response and signals a speaker to play the response.

Another type of puzzle that is provided by the invention has map puzzle pieces that are each distinctively shaped to symbolize a particular geographical region. Corresponding distinctively shaped trays also symbolize the geographical regions. Each of the trays fits only the map puzzle piece that symbolizes the same geographical region as the tray. Each the trays has a sensor actuated by a projection of the map puzzle piece. When the matching puzzle piece is properly fitted in the tray, the puzzle plays information relating to the geographic region, such as a country name, a national capitol, a national slogan, a national nickname, and a national song. If the geographical region is the United States of America, the information can be a state name, a state capitol, a state slogan, a state nickname or a state song.

Some puzzles of the invention are equipped with diaphragm switches arranged in a planar array, including a group of upper layer conductors and a group of lower layer conductors. The puzzle pieces are shaped to fit distinctive trays that contain the diaphragm switches for sensing the presence of the puzzle piece in the correct tray. Each of the upper and lower layer conductors is connected to an electrical current source that charges the conductors to a measurable voltage. Closing or opening each one of the diaphragm switches causes an identifiable change in the voltage of one of the upper and lower layer conductors. A microprocessor detects the change and identifies which one of the diaphragm switches has closed. Based on this information, the microprocessor sends an appropriate fact, song or story to a speaker in order to reward the person who placed the puzzle piece in the correct tray.

Interactive puzzles including maps other than that of the United States of America are contemplated. Also, interactive puzzles which include puzzles not based on maps are contemplated.

### BRIEF DESCRIPTION OF THE DRAWINGS

FIG. 1 is a front view of puzzle of the invention;

FIG. 2 is a partial front view of the puzzle depicted in FIG. 1, with puzzle pieces removed to reveal trays, hollows and actuating buttons;

FIG. 3 is an enlarged view of the New Mexico puzzle depicted in FIG. 1;

FIG. 4 is a perspective view of the New Mexico puzzle depicted in FIG. 1, showing a projection on the underside of the piece;

FIG. 5 is a perspective view of the puzzle depicted in FIG. 1, showing a storage drawer in open position;

FIG. 6 is a perspective view of the puzzle depicted in FIG. 1, with the cover piece removed to reveal an electrical circuit;

FIG. 7 is a partial perspective view of the puzzle depicted in FIG. 1, showing actuating buttons in a flexible planar array;

FIG. 8 is a partial perspective view of a dome layer of the invention; and

FIG. 9 is a partial perspective view of a dome layer, an upper layer and a lower layer of the planar array of the invention.

### DETAILED DESCRIPTION OF PREFERRED EMBODIMENTS

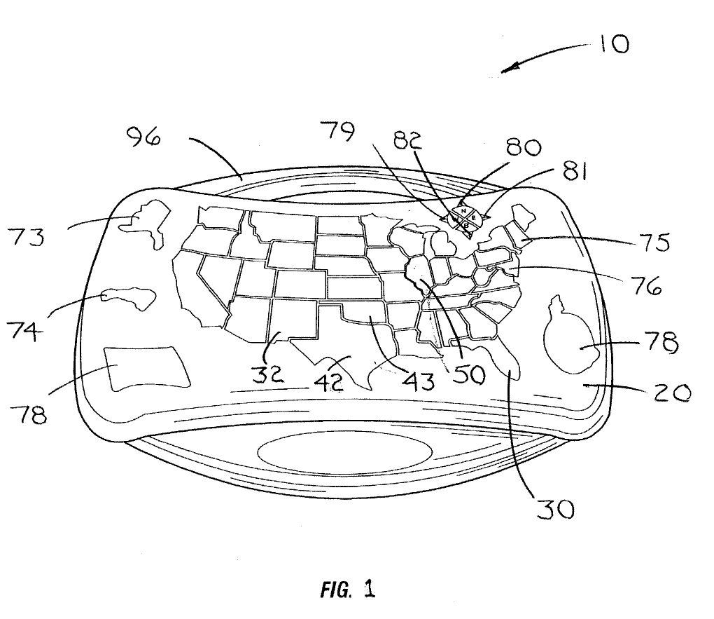

In a preferred embodiment, the invention provides an interactive, electronic, talking puzzle 10 for amusing and creatively stimulating children. As depicted in FIG. 1, puzzle 10 includes a puzzle board 20, an interactive map 30 and puzzle pieces corresponding to particular States of the United States of America. For example, map 30 includes New Mexico puzzle piece 32, Texas puzzle piece 42, Oklahoma puzzle piece 43 and Illinois puzzle piece 50, among others. Regional puzzle pieces 75, 76 represent groups of relatively smaller States whose puzzle pieces would be too small to handle conveniently when manufactured to the scale employed for the individual state puzzle pieces. Other puzzle pieces resemble the American flag 77, the Statue of Liberty 78 and principal points of the compass 79-82.

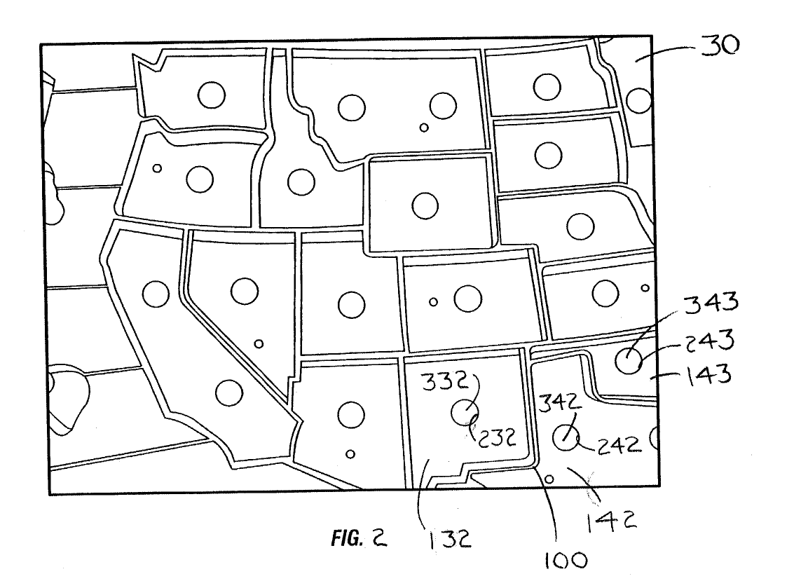

As can be seen in FIG. 2, interactive map 30 includes form-fitting trays such as New Mexico tray 132, Texas tray 142, and Oklahoma tray 143, which are bordered by wall 100 and accept matching puzzle pieces 32, 42 and 43, respectively. Each of trays 132, 142, and 143 is shaped as the corresponding state is usually depicted in a Mercator projection map. Additionally, as depicted in FIG. 2, trays 132, 142 and 143 define hollows 232, 242 and 243, which accept distinctively positioned projections formed by the undersides of the puzzle pieces, such as ridge or projection 132 formed by the underside of New Mexico puzzle piece 32 (best seen in FIG. 4.).

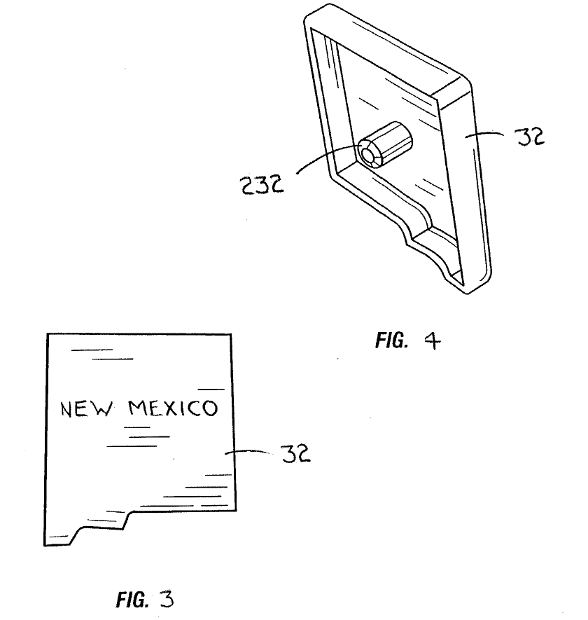

FIG. 3 is a front view of puzzle piece 32, which symbolizes the state of New Mexico. As can be seen, piece 32 is marked with the name of the state and shaped as New Mexico is usually depicted in a map. Both the markings and the shape suggest the concept of New Mexico. FIG. 4 is a perspective view of New Mexico puzzle piece 32 showing projection 132. These two levels of identification, more specifically distinctive shape and projection positioning, ensure that the audio reward can only be obtained by properly orienting an appropriate puzzle piece in the correct tray.

Alaska puzzle piece 73 and Hawaii puzzle piece 74 match trays 173 (not shown) and 174 (not shown), respectively, which are situated apart from those of puzzle pieces for the contiguous states in interactive map 30. The puzzle pieces for American flag 77, the Statue of Liberty 78 and principal points of the compass 79-82 each have their own dedicated trays 177-182, respectively.

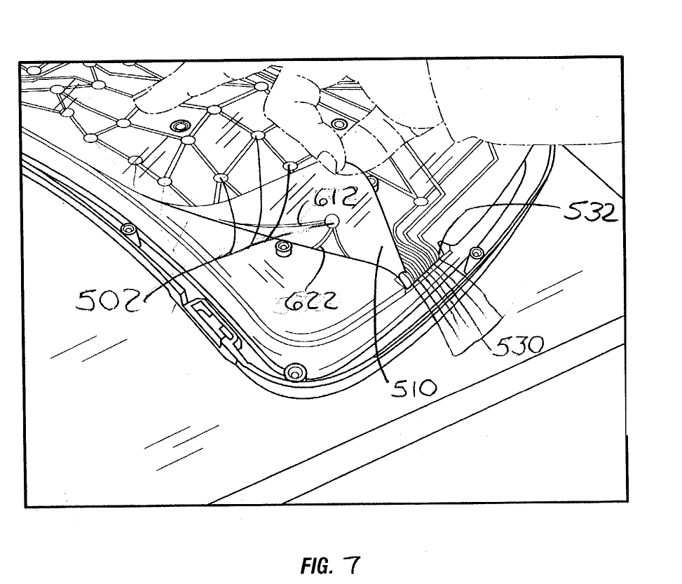

Preferably, sensors or actuating buttons such as actuating buttons 332, 342 and 343, depicted in FIG. 2, open and close contacts for an electrical circuit 580 (best seen in FIG. 6) located within puzzle board 20. A microprocessor (not shown) having electronic storage, programming and signaling capabilities and a speaker (not shown) are located in puzzle board 20 and powered, preferably, by AA batteries. Suitable packaging, known in the industry as “try-me” packaging, permits potential purchasers to test these functions without removing puzzle board 20 from the packaging.

When a puzzle piece, for example, New Mexico puzzle piece 32, is fitted into its matching tray 132 with proper orientation, a projection, such as projection 232, penetrates hollow 242. Further insertion of puzzle piece 32 into tray 132 depresses a membrane switch or other actuating button 432 located in hollow 432, so as to trigger a predetermined audio reward. Orienting New Mexico puzzle piece 32 properly and pressing it into the correct tray 132 earns a verbal reward of “New Mexico: Land of Enchantment! State capitol: Santa Fe!” Orienting Illinois puzzle piece 50 properly and pressing it into tray 150 is met with “Illinois: The Prairie State! State capital: Springfield!” Orienting Statue of Liberty puzzle piece 78 properly and pressing it into tray 178 activates a rendition of “America the Beautiful.” Success with the American flag puzzle piece 77 is rewarded with a recitation of the “Pledge of Allegiance.”

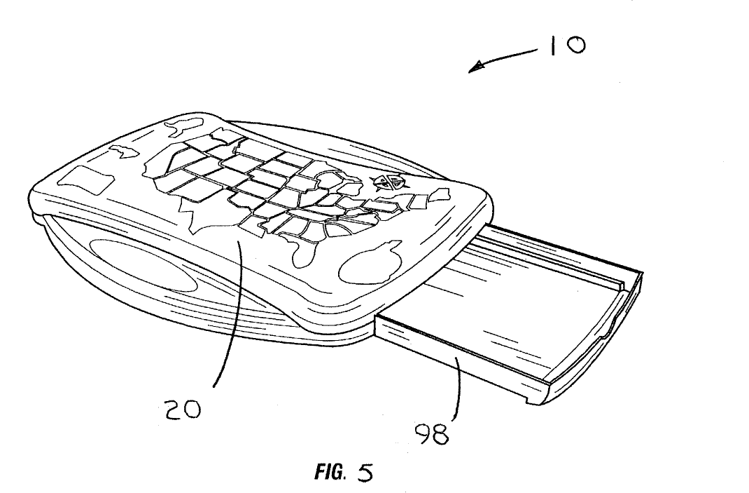

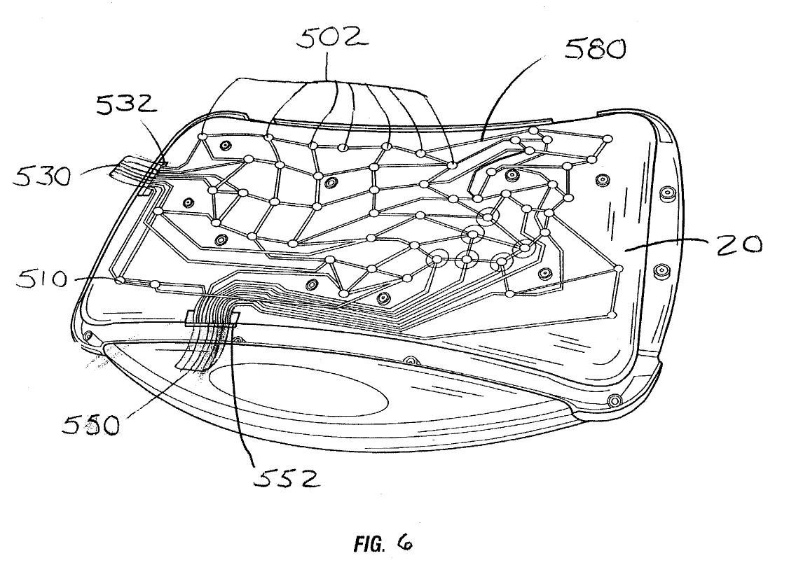

FIG. 5 depicts a storage drawer in which puzzle pieces may be stored. Drawer 98 normally resides within the right side of puzzle board 20. Carrying handle 96 is located on the top portion of puzzle board 20, as shown in FIG. 1.

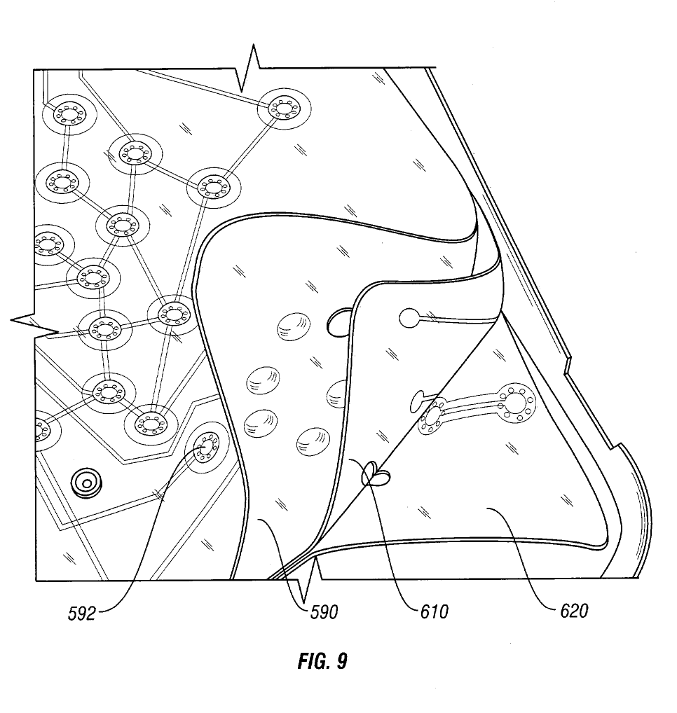

As can be seen in FIG. 6, an electrical circuit 580 includes seven upper conductors 530 arranged as input-output port 532 in the form of a flat ribbon-cable. Upper conductors 530 separate and extend individually as upper conductors 612 (best seen in FIG. 9) to various points along puzzle board 20 where a puzzle piece, such as puzzle piece 32, is expected to depress one of the actuating buttons 502, such as actuating button 432. At these points, the conductors 530 are widened to form contacts 614 (best seen in FIG. 9), which are utilized as components of the actuating buttons 502.

Also visible in FIG. 6 are eight lower conductors 550, which are arranged as input-output port 552. Eight conductors extend individually as lower conductors 622 (best seen in FIG. 9) to points where upper conductors 612 are widened to form upper contacts 614 of the actuating buttons 502. At these points, lower conductors 622 pass beneath upper conductors 612 and are widened to form lower contacts 624 (best seen in FIG. 9), which are utilized as components of the actuating buttons 502. FIG. 6 illustrates the manner in which the actuating buttons 502 are arranged to form planar array 510.

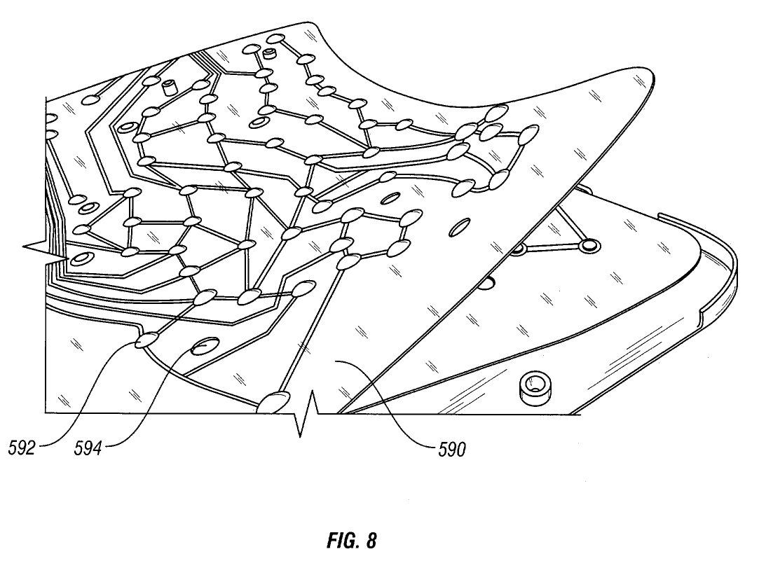

As depicted in FIG. 7, planar array 510 is a thin, relatively flexible assembly including upper and lower conductors 510, 530 and at least three distinct layers 590, 610 and 620, which are not distinguishable in FIG. 7. The layers 590, 610 and 620, which constitute planar array 510, are described below with reference to FIGS. 8 and 9.

FIG. 8 depicts dome layer 590, which is the topmost of the layers 590, 610 and 620. Dome layer 590 is composed of a nonconductive resilient material so that a plurality of domes 592 formed in dome layer 590, which tend to return or “pop-up” to their previous positions after being depressed and released. Each dome 592 is positioned to overlay one of the actuating buttons 502. Also visible in FIG. 8 are registration holes 594, which facilitate correct positioning of dome layer 590 with respect to puzzle board 20.

In the pop-up position, each of domes 592 create a protected volume in which one of the actuating buttons 502 may freely operate. The actuating buttons 502 are normally open electrical contacts. When depressed, each of domes 592 transmits a force from above for closing one of the contacts 614, 624 (best seen in FIG. 9) of the actuating buttons 502. Dome layer 590 may optionally be affixed to the other layers 610, 630 by, for example, an adhesive.

FIG. 9 illustrates dome layer 590, upper layer 610 and lower layer 630 as they appear when partially separated from each other. Upper layer 610 and lower layer 630 are flexible, resilient nonconductors of electricity.

Upper conductor 612 is a conductive strip of a material, such as a sheet of metal or the conductive residue of a conductive ink. Upper conductor 612 includes contacts 614, which are sections where upper conductor 612 is wider than normal. Upper conductor 612 is printed on or otherwise affixed to the lower surface of upper layer 610.

Lower conductor 622 is substantially similar to upper conductor 612, except that lower conductor 622 is printed on or otherwise affixed to the upper surface of lower layer 620. Lower conductor 622 includes contacts 624, which are sections where lower conductor 622 is wider than normal. Several nonconductive bumps or spheroids 626 are arranged about each of the lower contacts 622 and affixed to the upper surface of lower layer 620.

Bumps 624 are located at or near the edges of each of the lower contacts 624 to separate upper contacts 612 from lower contact 622, while the respective one of the domes 592 is in the pop-up position. The centers of upper and lower contacts 612, 622 are separated only by an air gap. When the respective dome 592 is depressed to transmit a sufficient downward force to contact 612, bumps 624 and/or upper layer 610 deform so that upper contact 612 and lower contact 614 meet in a closed electrical connection.

A direct current voltage is impressed on each of the upper conductors 530. Each of the lower conductors 550 at is electrically connected to ground. The microprocessor (not shown) monitors the voltage differences between each of the upper conductors 530 at input-output point 532 and each of the lower conductors 550 at input-output point 552. At least one of these voltage differences changes when one of the actuating buttons 502 is depressed to the closed position. Based on this change in voltage differences, the microprocessor (not shown) sends a message or recording to a speaker (not shown). The message or recording is appropriate for the concept associated with the particular actuating button 502.

By solving the interactive puzzle of the invention, children learn important facts and geographic relationships, such as the relative locations of the States of the United States of America. Children learn the capital cities of states and nations and the slogans associated with those regions. Children also learn and recite the “Pledge of Allegiance” and the song “America the Beautiful.” Children learn the principal compass directions. The puzzle of this invention may be solved repeatedly, and an audio reward applauds each success.

While only a few, preferred embodiments of the invention have been described above, those of ordinary skill in the art will recognize that these embodiments may be modified and altered without departing from the central spirit and scope of the invention. The preferred embodiments described above are to be considered in all respects as illustrative and not restrictive.

That which is claimed is:

1. An interactive puzzle, which comprises:
a plurality of distinctively shaped pieces, each of the pieces shaped or marked to symbolize a concept, and each of the pieces having a projection;
a plurality of distinctively shaped trays, each of the trays shaped or marked to symbolize one of the concepts, each of the trays shaped to fit only the piece symbolizing the concept; and
each of the trays having a sensor which is actuated by the projection of the piece symbolizing the concept when the piece symbolizing the concept is fitted in the tray.
means for determining whether and which one of the sensors is actuated; and
means for playing, upon actuation of each of the sensors, an audio response dedicated to the actuated sensor.

2. The puzzle of claim 1 in which each of the pieces is shaped to symbolize a geographical region, and the audio response includes information relating to the region.

3. The puzzle of claim 2 in which the information is selected from the group consisting of a country name, a national capitol, a national slogan, a national nickname, and a national song.

4. The puzzle of claim 2 in which the information is selected from the group consisting of a state name, a state capitol, a state slogan, a state nickname, and a state song.

5. An interactive puzzle, which comprises:
a plurality of distinctively shaped pieces, each of the pieces shaped to symbolize a geographical region, and each of the pieces having a projection;
a plurality of distinctively shaped trays, each of the trays shaped to symbolize one of the geographical regions, each of the trays shaped to fit only the piece symbolizing the geographical region; and each of the trays having a sensor which is actuated by the projection of the piece symbolizing the geographical region when the piece symbolizing the geographical region is fitted in the tray.
means for determining whether and which one of the sensors is actuated; and
means for playing, upon actuation of each of the sensors, an audio response dedicated to the actuated sensor and including information relating to the geographic region.

6. The puzzle of claim 5 in which the information is selected from the group consisting of a country name, a national capitol, a national slogan, a national nickname, and a national song.

7. The puzzle of claim 5 in which the information is selected from the group consisting of a state name, a state capitol, a state slogan, a state nickname, and a state song.

8. The puzzle of claim 5 in which the shapes of the pieces resemble the shapes of states of the United States of America.

9. The puzzle of claim 5 in which the pieces are marked with the names of states of the United States of America.

10. The puzzle of claim 5 in which the audio response includes information about a state of the United States of America.

11. The puzzle of claim 5 which includes push buttons that actuate means for playing a recording of the Pledge of Allegiance.

12. The puzzle of claim 5 which includes push buttons that actuate means for playing a patriotic song.

13. The puzzle of claim 5 in which each of the trays includes a receptacle that limits access to the tray's sensor.

14. The puzzle of claim 5 in which the sensors are diaphragm switches.

15. The puzzle of claim 14 in which the diaphragm switches are arranged in a planar array with each of the first contacts of the diaphragm switches electrically connected to one of a plurality of first conductors, each of the first conductors electrically connecting two or more first contacts in series, and each of the second contacts of the diaphragm switches electrically connected to one of plurality of second conductors, each of the second conductors electrically connecting two or more second contacts in series and each of the second contacts adjacent one or more resilient, nonconductive bumps that hold the second contact in a normally open position relative to the respective first contact.

16. The puzzle of claim 14 in which closing one of the diaphragm switches completes a uniquely determinable electrical circuit that is associated with the diaphragm switch.

17. The puzzle of claim 14 which includes a speaker for playing the audio responses and a microprocessor; and in which closing each of the diaphragm switches causes an identifiable voltage change in the first conductor and the second conductor; the microprocessor capable of detecting the voltage change, determining which one of the diaphragm switches is associated with the voltage change and sending to the speaker the audio response dedicated to the associated diaphragm switch.

18. An interactive puzzle, which comprises:
a plurality of diaphragm switches arranged in a planar array, each of the diaphragm switches having a first contact and a second contact;
a plurality of first conductors, each of the first conductors electrically connecting two or more first contacts in series, each of the first contacts electrically connected to one of the first conductors;
a plurality of second conductors, each of the second conductors electrically connecting two or more second contacts in series, each of the second contacts of the diaphragm switches electrically connected to one of the second conductors; the first conductors or the second conductors impressed with an electrical potential so that closing or opening each one of the diaphragm switches causes an identifiable change in the voltage of the first conductors and the second conductors;
a plurality of distinctively shaped pieces, each of the pieces shaped or marked to symbolize a concept, and each of the pieces having a projection;
a plurality of distinctively shaped trays, each of the trays shaped or marked to symbolize one of the concepts, each of the trays shaped to fit only the piece symbolizing the concept; and
each of the trays surrounding one of the diaphragm switches, the diaphragm switch being actuated by the projection of the piece symbolizing the concept when the piece symbolizing the concept is fitted in the tray.
a speaker for playing audio responses, each of the audio responses dedicated to one of the diaphragm switches; and
a microprocessor capable of detecting the voltage change in the first conductor and the second conductor, determining which one of the diaphragm switches is associated with the voltage change and sending to the speaker the audio response dedicated to the associated diaphragm switch in order to reward fitting the piece into the tray.

19. The puzzle of claim 18 in which each of the pieces is shaped to symbolize a geographical region, and the audio response includes information relating to the region.

20. The puzzle of claim 18 in which each of the pieces is shaped to resemble the shape of one of the states of the United States of America, and the audio response includes information selected from the group consisting of a state name, a state capitol, a state slogan, a state nickname and a state song.
